(19) United States
(12) Patent Application Publication
(10) Pub. No.: US 2019/0368572 A1
(43) Pub. Date: Dec. 5, 2019

(54) ROTARY DAMPER

(71) Applicants: Adam Plesniak, Huntington beach, CA (US); Mark Henderson, La Verne, CA (US); Mark Ventura, Huntington Beach, CA (US); David Pope, Gilbert, AZ (US)

(72) Inventors: Adam Plesniak, Huntington beach, CA (US); Mark Henderson, La Verne, CA (US); Mark Ventura, Huntington Beach, CA (US); David Pope, Gilbert, AZ (US)

(21) Appl. No.: 16/424,353

(22) Filed: May 28, 2019

Related U.S. Application Data
(60) Provisional application No. 62/677,469, filed on May 29, 2018.

(51) Int. Cl. F16F 15/16; F16F 13/06; H02S 20/32; H02S 30/10

(52) U.S. Cl. CPC F16F 15/161; H02S 30/10; H02S 20/32; F16F 13/06

(57) ABSTRACT

A rotary damper includes a tubular body having interface elements attached thereto for fixedly mounting the body on a mounting structure, a torque structure interface rotatably mounted within the body so as to define a cavity, the cavity having opposed spaced apart surfaces, one of the spaced apart surfaces being a part of the body and the other of the spaced apart surfaces being a part of the torque structure interface, and the torque structure interface being tubular shaped to receive a torque structure therethrough for mutual rotation of the torque structure interface and the torque structure, and shear structures positioned in the cavity and providing non-Newtonian damping on the torque structure interface relative to the tubular body during rotation of the torque structure interface relative to the tubular body.

### CROSS-REFERENCE TO RELATED APPLICATION

This application claims the benefit of U.S. Provisional Patent Application No. 62/677,469, filed 29 May 2018.

### FIELD OF THE INVENTION

This invention relates to damper devices, and more specifically to rotary damper devices.

### BACKGROUND OF THE INVENTION

The term “damper”, as used in the present context, is a device for reducing mechanical vibration and undesired movement, such as a shock absorber on a motor vehicle. Types of dampers can include linear dampers, rotary dampers and the like. Mechanical vibrations can be linear, such as damped by a shock absorber, or rotational, as seen with rotary motion structures such as solar trackers or other structures rotated on an axis. The present invention is concerned with rotary motion structures. Some rotary motion applications of dampers, such as actuation of solar trackers, also have a need for motion dampening against fast acting or harmonic torques, such as wind buffering (activating at about 1.5 Hz). This need today is generally met through the use of linear dampers. The devices work by forcing a dampening fluid such as hydraulic oil through a small orifice in a double acting cylinder thereby creating a dampening force. While somewhat effective, this design does not yield the ideal kinematic dampening solution for rotary applications and particularly on solar trackers. These devices provide a linear (Newtonian) dampening response when a non-linear response is most desirable

Commercially available rotary dampers can be obtained, but they are small in size and have a small rated torque capacity. The design of these commercially available dampers does not allow them to carry loads and torques seen in larger size applications, i.e. their design does not scale. Additionally, they employ silicone oils or gels which result in a mostly linear (Newtonian) dampening response.

It would be highly advantageous, therefore, to remedy this and other deficiencies inherent in the prior art.

Accordingly, it is an object of the present invention to provide a new and improved rotary damper.

It is another object of the present invention to provide a new and improved rotary damper with non-linear dampening response.

It is yet another object of the present invention to provide a new and improved rotary damper with non-linear dampening response incorporated into a solar tracking system.

### SUMMARY OF THE INVENTION

Briefly to achieve the desired objects and advantages of the instant invention a new and novel rotary damper is disclosed. The rotary damper includes a tubular body having interface elements attached thereto for fixedly mounting the body on a mounting structure, a torque structure interface rotatably mounted within the body so as to define a cavity, the cavity having opposed spaced apart surfaces, one of the spaced apart surfaces being a part of the body and the other of the spaced apart surfaces being a part of the torque structure interface, and the torque structure interface being tubular shaped to receive a torque structure therethrough for mutual rotation of the torque structure interface and the torque structure, and shear structures positioned in the cavity and providing non-Newtonian damping on the torque structure interface relative to the tubular body during rotation of the torque structure interface relative to the tubular body.

The desired objects and advantages of the instant invention are further achieved in a preferred embodiment of a rotary damper including a tubular body having interface elements attached thereto for fixedly mounting the body on a mounting structure. The damper further includes a torque structure interface rotatably mounted within the body so as to define a cavity, the cavity having opposed spaced apart surfaces, one of the spaced apart surfaces being a part of the body and the other of the spaced apart surfaces being a part of the torque structure interface, and the torque structure interface being tubular shaped to receive a torque structure therethrough for mutual rotation of the torque structure interface and the torque structure. Shear structures are positioned in the cavity and include dilatant damper material filling the cavity and shear elements extending into the dilatant damper material from one or both of the opposed spaced apart surfaces of the cavity. The shear elements in cooperation with the dilatant damper material provide non-Newtonian damping on the torque structure interface relative to the tubular body during rotation of the torque structure interface relative to the tubular body.

The desired objects and advantages of the instant invention are further achieved in a preferred embodiment of a rotary damper incorporated into a solar tracking system, the solar tracking system including a plurality of linearly spaced apart posts with a longitudinal axis of rotation extending there between, a torque structure carrying solar panels rotatably mounted on the posts for limited rotation around the longitudinal axis. The rotary damper includes a tubular body having interface elements attached thereto for fixedly mounting the body on one of the linearly spaced apart posts. The rotary damper further includes a torque structure interface rotatably mounted within the body so as to define a cavity, the cavity having opposed spaced apart surfaces, one of the spaced apart surfaces being a part of the body and the other of the spaced apart surfaces being a part of the torque structure interface, and the torque structure interface being tubular shaped to receive the torque structure therethrough for mutual rotation of the torque structure interface and the torque structure. Shear structures are positioned in the cavity and include dilatant damper material filling the cavity and shear elements extending into the dilatant damper material from one or both of the opposed spaced apart surfaces of the cavity, the shear elements in cooperation with the dilatant damper material providing non-Newtonian damping on the torque structure interface relative to the tubular body during rotation of the torque structure interface relative to the tubular body.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of a solar panel assembly coupled in series, illustrating various components including a rotary damper according to the present invention;

FIG. 2 is a front perspective view of a rotary damper in accordance with the present invention;

FIG. 3 is a sectional view of the rotary damper taken along lines 3-3 of FIG. 2;

FIG. 4 is a rear perspective view of the rotary damper of FIG. 2;

FIG. 5 is a sectional view of the rotary damper taken along lines 5-5 of FIG. 2;

FIG. 6 is a graph illustrating desired damping effect;

FIG. 7 is a chart illustrating damping effect of various material types;

FIG. 8 is a front perspective view of another rotary damper in accordance with the present invention;

FIG. 9 is a sectional view of the rotary damper taken along lines 9-9 of FIG. 8;

FIG. 10 is a sectional view of the rotary damper taken along lines 10-10 of FIG. 8;

FIG. 11 is a sectional side perspective view of another embodiment of rotary damper according to the present invention, using walls as shear structures;

FIG. 12 is a sectional front view of the rotary damper of FIG. 11;

FIG. 13 is a perspective view of yet another embodiment of a rotary damper according to the present invention, using vanes as shear structures;

FIG. 14 is a sectional view taken along lines 14-14 of FIG. 13;

FIG. 15 is a sectional view taken along line 15-15 of FIG. 13, illustrating vanes in the full shear orientation;

FIG. 16 is a sectional view taken along line 15-15 of FIG. 13, illustrating vanes in the partial shear orientation;

FIG. 17 is a sectional view taken along line 15-15 of FIG. 13, illustrating vanes in the minimal shear orientation;

FIG. 18 is a front sectional view of yet another embodiment of a rotary damper according to the present invention, using a coil spring as a damping structure;

FIG. 19 is a side sectional view of the rotary damper of FIG. 18;

FIG. 20 is a front sectional view of another embodiment of a rotary damper according to the present invention, using compression springs as damping structures;

FIG. 21 is a side sectional view of the rotary damper of FIG. 20;

FIG. 22 is a side sectional view of another embodiment of a rotary damper according to the present invention, using braking mechanisms for damping structures; and

FIG. 23 is a front sectional view of the rotary damper of FIG. 22;

### DETAILED DESCRIPTION OF THE DRAWINGS

Torque structures used in many industries and applications, are employed in combination with a drive system to rotate a structure. As an example, solar trackers employ a torque structure, such as a tube, shaft or other structures, to support and rotate a frame carrying solar panels around an axis. These solar trackers can be used singly or in series as desired. Other industries employ torque structures to rotate other structures in a similar manner. Dampening of unwanted vibrations and rotational movements is often desirable. The rotary damper of the present invention can be employed on conventional solar tracker systems, wherein the torque structure is rotated by employing an actuator such as a slew drive to turn the torque structure at one position or on other systems such as taught in pending U.S. patent application Ser. No. 15/886,782, entitled DISTRIBUTED TORQUE SINGLE AXIS SOLAR TRACKER, filed Feb. 1, 2018 and included herein by reference. It will further be understood that while the rotary damper of the present invention is uniquely capable of providing damping for torque structures on solar trackers (either singly or in series), it can also be used to damp rotating torque structures in other industries and applications.

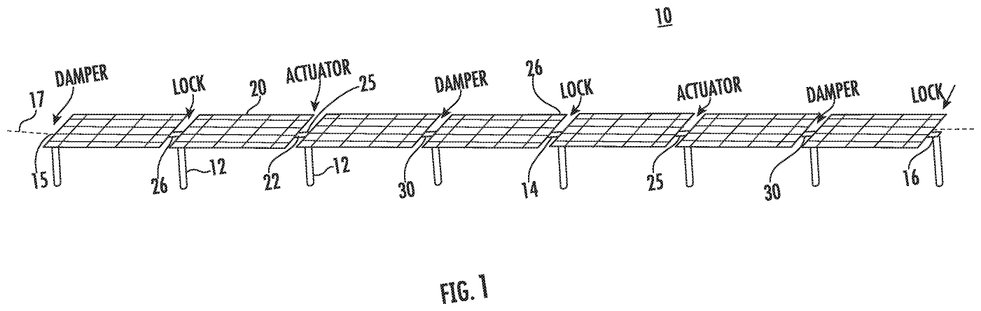

Turning now to the drawings in which like reference characters indicate corresponding elements throughout the several views, attention is first directed to FIG. 1, which illustrates a solar tracker system, generally designated 10. Solar tracker system 10 is provided to illustrate a potential environment in which a rotary damper according to the present invention, can be employed. In this example, solar tracker system 10 includes a plurality of linearly spaced apart posts 12. A torque structure 14, which can be a tubular member, a solid axle, a lattice structure, a frame and the like, extends across the plurality of posts 12 and is rotationally coupled to each. Torque structure 14 includes opposing ends 15 and 16, and a longitudinal axis of rotation 17 extending there between. It will be understood that torque structure 14 can be a single continuous length or constructed of a plurality of segments. It will also be understood that the number of posts 12 and the length of torque structure 14 is determined by the size and number of solar panels 20 supported thereby. In this example, solar panels 20 are coupled to torque structure 14 with brackets 22. Thus, as torque structure 14 is rotated about longitudinal axis of rotation 17, panels 20 are rotated to maximize solar collection. One or more rotary dampers 30 according to the present invention can be employed on posts 12 to damp undesired rotation of torque structure 14. Single or multiple rotary dampers 30 can be employed as desired. In the example illustrated, solar tracker system 10 employs a plurality of actuators 25 to rotate torque tube structure 14 at multiple points. Actuators 25 are mounted on selected posts 12 so as to be interspersed with rotary dampers 30 and lock devices 26. Rotary dampers 30 are mounted on top of posts 12 and receive torque structure 14 therethrough.

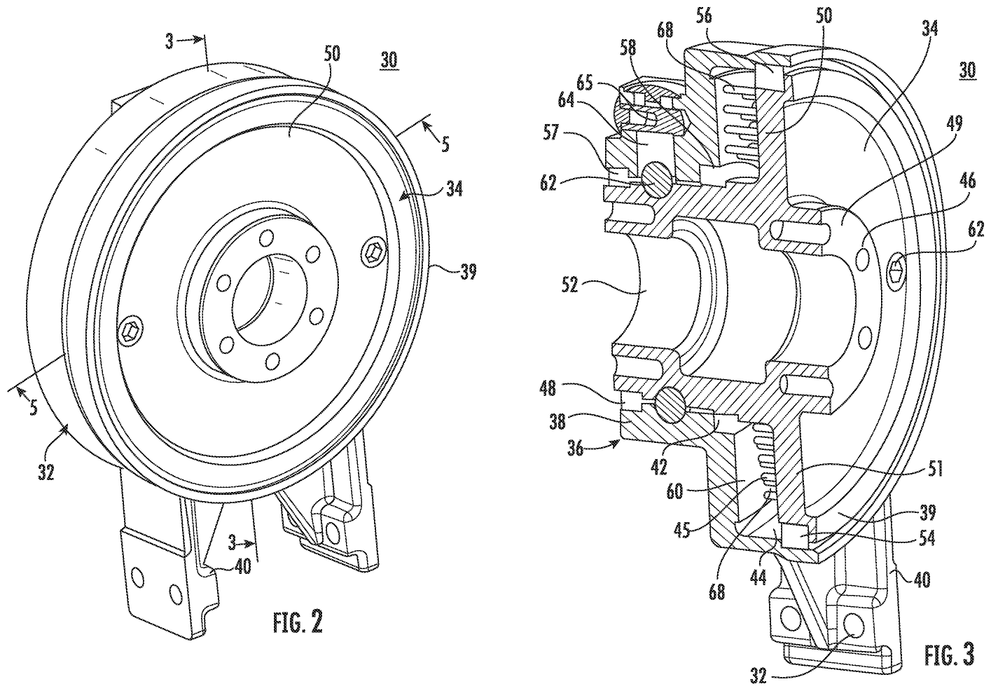

Turning now to FIGS. 2 and 3, a rotary damper 30 according to the present invention is illustrated. Rotary damper 30 includes a housing 32 and a top plate 34 rotatably coupled thereto. Housing 32 includes a body 36 having an inner end 38 and an outer end 39, and interface elements 40 extending radially outwardly from body 36 proximate outer end 39. Interface elements 40 are employed to couple rotary damper 30 to posts 12 and like structures. Body 36 is generally tubular shaped with an inner surface 42 at inner end 38, an outwardly stepped inner surface 44 at outer end 39, and a shoulder 45 extending radially outward from inner surface 42 to inner surface 44. Top plate 34 includes a torque structure interface 46 having an inner end 48 and an outer end 49, and a plate member 50 extending radially outwardly from torque structure interface 46 proximate outer end 49. Torque structure interface 46 is tubular shaped to receive a torque structure therethrough, or coupled thereto. Here it should be understood that “tubular” is not limited to round but could have any cross-sectional shape (e.g. square, rectangular, oval, irregular, etc.) and the inner opening through the tube could have a different cross-sectional shape than the outer perimeter of the tube. Thus, “tubular shape or shaped” is simply defined as an outer body or shell with an opening through the center. Plate member 50 has an inner surface 51 directed toward inner end 48. Torque structure interface 46 is received through body 36 with an outer surface 52 at inner end 48 overlying inner surface 42 of body 36, and an outer edge 54 of plate member 50 positioned adjacent inner surface 44 at outer end 39. A seal member 56 is carried in a groove formed in outer edge 54 of plate member 50. Seal member 56 seals any gap between plate member 50 and body 36. A seal member 57 is carried between inner surface 42 and outer surface 52 at inner ends 38 and 48, respectively. Seal member 57 seals any gap between torque structure interface 46 and body 36. A seal member 58 is carried between inner surface 42 and outer surface 52 at shoulder 45. Seal members 58 seals any gaps between torque structure interface 46 and body 36. A damper material cavity 60 is formed encircling torque structure interface 46 and defined by shoulder 45 and plate member 50. Damper material carried within damper material cavity 60 is retained by the presence of seal members 56 and 58. Closeable fill holes 61 are formed through plate member 50 in communication with damper material cavity 60 to facilitate injection of damper material into damper material cavity 60.

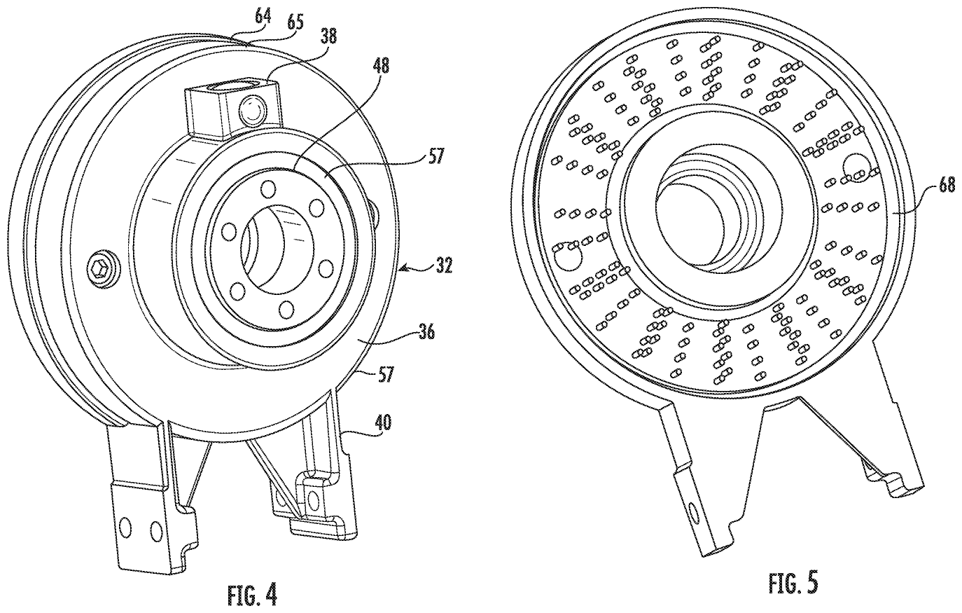

With continued reference to FIG. 3, and additional reference to FIG. 4, top plate 34 is free to rotate relative to body 36 with seals 56, 57 and 58 sealing spaces therebetween from the outer environment and preventing leakage of materials contained therebetween. Rotation is facilitated by ball bearings 62 captured between inner surface 42 and outer surface 52 preferably within bearing races formed therein. Seal 57 specifically protects bearings 62 from the outer environment. An aperture structure 64 is formed in body 36 for receiving and directing bearing 62 into position. Aperture structure 64 is closable by a plug 65.

With continued reference to FIG. 3, and additional reference to FIG. 5, shear structures 68 are illustrated. In this embodiment, shear structures 68 are pins extending from one or both of shoulder 45 and surface 51 into damper material cavity 60. Here it should be understood that the term “pins” is defined as any structure with virtually any shape extending outwardly from shoulder 45 and/or surface 51 which is attached to or formed as a part of shoulder 45 and surface 51, respectively. Preferably, half of the pins extend from shoulder 45 and half extend from surface 51, inter-passing during relative rotation of top plate 34 and body 36. Shear structures 68 shear the dampening material carried within damper material cavity 60. Seals 56 and 58 provide an equal pressure onto the dampening material when it is placed into shear from the movement of the shear pins. At low speeds or frequency input, the damper and damper material in shear is designed to flow easily, providing little dampening force. At high speeds or frequency input, the damper and damper material in shear is designed to provide a large resisting damper force.

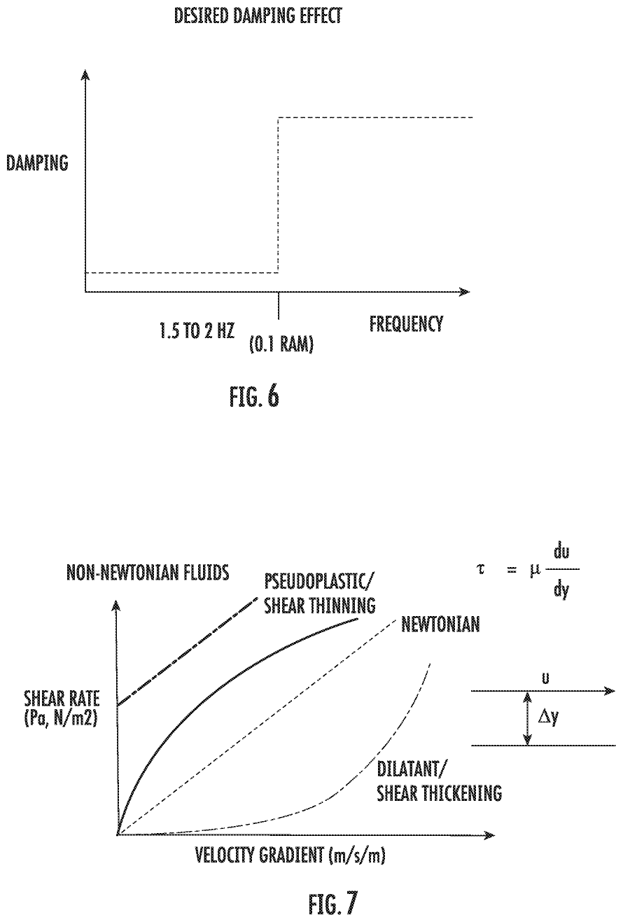

Turning now to FIGS. 6 and 7, FIG. 6 illustrates the ideal kinematic dampening solution for solar applications. Referring to FIG. 6. the ideal dampening response is a very small, close to zero resistance torque (˜0 NM) at low rotary speeds and frequencies (0.1 RPM) as seen during nominal drive operation, but a very large dampening torque (>1000 NM) at speeds higher than nominal solar tracker operating speed (>0.1 RPM, >1.5 to 2 Hz) and frequencies as seen in wind events. Thus, the rotary damper of the present invention is designed to provide a non-Newtonian dampening response. FIG. 7 illustrates the damping effect of various damping materials. When examining various potential damping materials, it is desirable that a non-Newtonian damping effect be provided. Specifically, it is desirable to employ a damping material that shows dilatant behavior which has a non-linear increase in shear rate with increased velocity gradient. Dilatant material is a recognized category of non-Newtonian fluid behavior where the shear viscosity increases with applied shear stress.

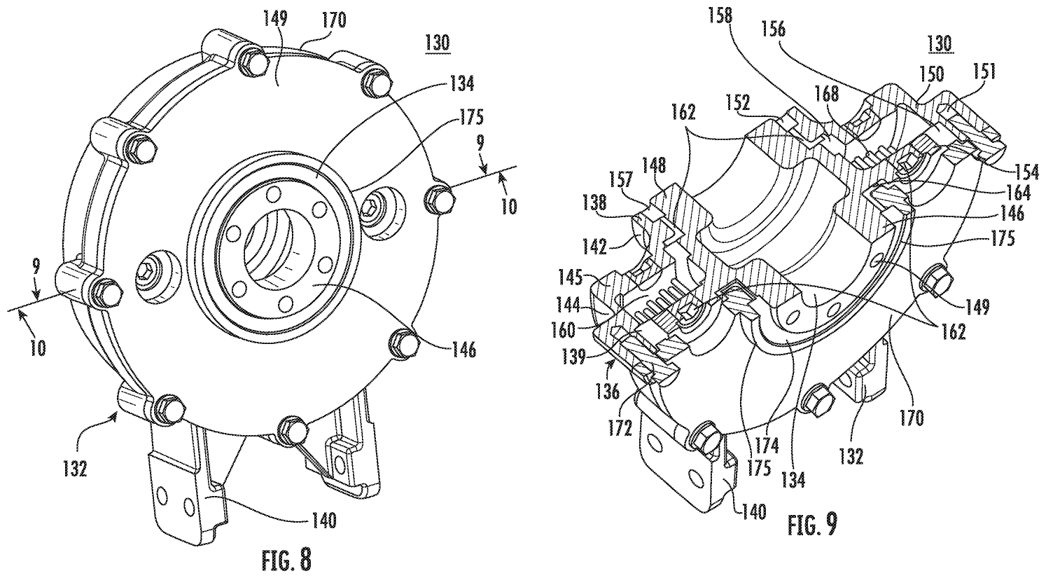

Turning now to FIGS. 8 and 9, another embodiment of a rotary damper generally designated 130, is illustrated. Rotary damper 130 is similar to rotary damper 30 with the inclusion of slip bearings instead of ball bearings. Rotary damper 130 includes a housing 132 and a top plate 134 rotatably coupled thereto. Housing 132 includes a body 136 having an inner end 138 and an outer end 139, and interface elements 140 extending radially outwardly from body 136 proximate outer end 139. Interface elements 140 are employed to couple rotary damper 130 to posts 12 and like structures. Body 136 is generally tubular shaped with an inner surface 142 at inner end 138, an outwardly stepped inner surface 144 at outer end 139, and a shoulder 145 extending radially outward from inner surface 142 to inner surface 144. Top plate 134 includes a torque structure interface 146 having an inner end 148 and an outer end 149, and a plate member 150 extending radially outwardly from torque structure interface 146 proximate outer end 149. Torque structure interface 146 is tubular shaped to receive a torque structure therethrough, or coupled thereto. Plate member 150 has an inner surface 151 directed toward inner end 148. Torque structure interface 146 is received through body 136 with an outer surface 152 at inner end 148 overlying inner surface 142 of body 136, and an outer edge 154 of plate member 150 positioned adjacent inner surface 144 at outer end 139. A seal member 156 is carried in by outer edge 154 of plate member 150. Seal member 156 seals any gap between plate member 150 and body 136. A seal member 157 is carried between inner surface 142 and outer surface 152 at inner ends 138 and 148, respectively. Seal member 157 seals any gap between torque structure interface 146 and body 136. A seal member 158 is carried between inner surface 142 and outer surface 152 at shoulder 145. Seal members 158 seals any gaps between torque structure interface 146 and body 136. A damper material cavity 160 is formed encircling torque structure interface 146 and defined by shoulder 145 and plate member 150. Damper material carried within damper material cavity 160 is retained by the presence of seal members 156 and 158. Closeable fill holes 161 are formed through plate member 150 in communication with damper material cavity 160 to facilitate injection of damper material into damper material cavity 160. A lock plate 170 body 136 capturing and retaining top plate 134 therebetween. Lock plate is coupled to body 136 preferably by fasteners 172 such as bolts and the like. Lock plate 170 includes a central aperture 174 through which outer end 149 of top plate 134 is received. A seal member 175 is positioned within aperture 174, between lock plate 170 and top plate 134. Seal member 175 permits relative rotation between lock plate 170 and top late 134.

With continued reference to FIG. 9, top plate 134 is free to rotate relative to body 136 with seals 156, 157 and 158 sealing spaces therebetween from the outer environment and preventing leakage of materials contained therebetween. Rotation is facilitated by slip bearings 162 captured between inner surface 142 and outer surface 152. Seal 157 specifically protects slip bearings 162 from the outer environment. Another slip bearing 164 is positioned between top plate 134 proximate outer end 149 and lock plate 170, protected by seal member 175.

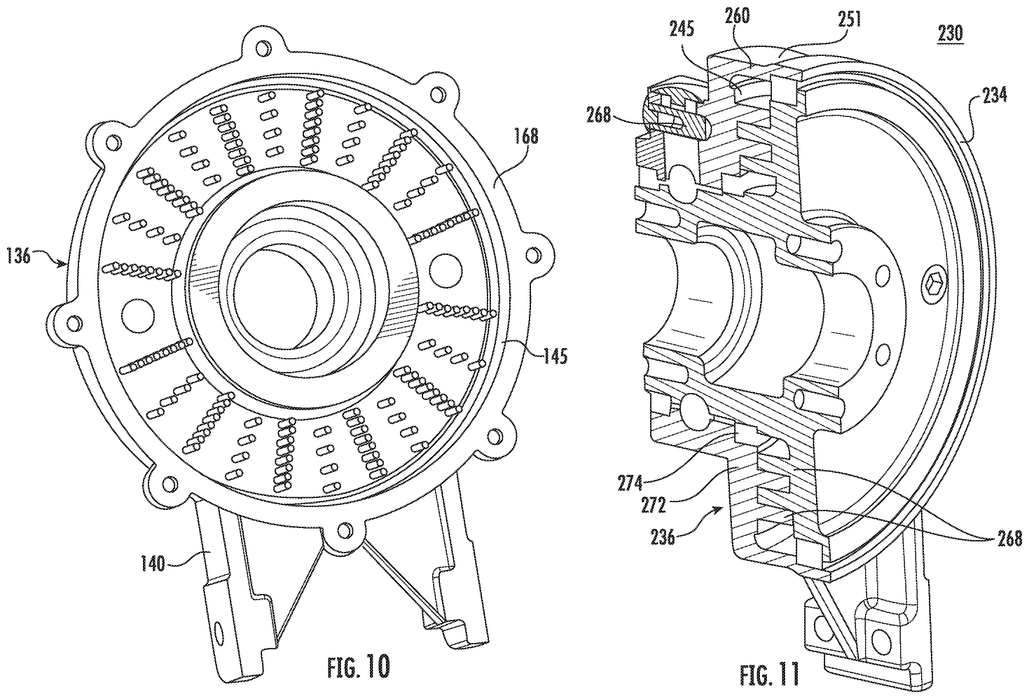

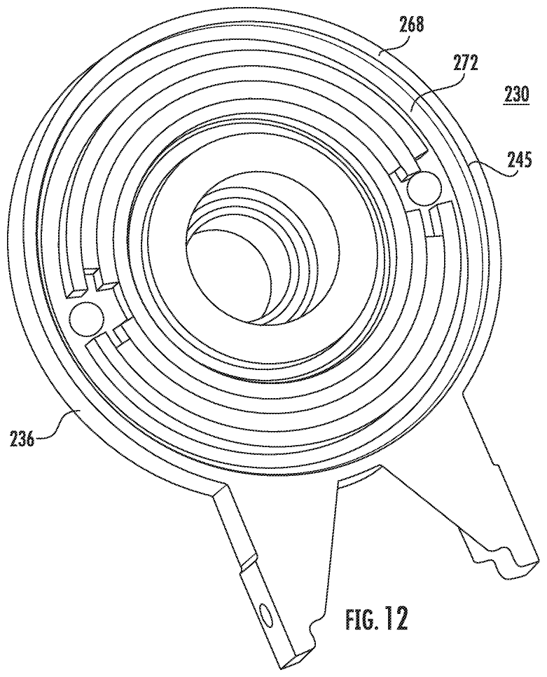

With continued reference to FIG. 9, and additional reference to FIG. 10, shear structures 168 are illustrated. In this embodiment, shear structures 168 are pins extending from one or both of shoulder 145 and surface 151 into damper material cavity 160. Preferably, half of the pins extend from shoulder 145 and half extend from surface 151, inter-passing during relative rotation of top plate 134 and body 136. Shear structures 168 shear the dampening material carried within damper material cavity 160. Seals 156 and 158 provide an equal pressure onto the dampening material when it is placed into shear from the movement of the shear pins. At low speeds or frequency input, the damper and damper material in shear is designed to flow easily, providing little dampening force. At high speeds or frequency input, the damper and damper material in shear is designed to provide a large resisting damper force.

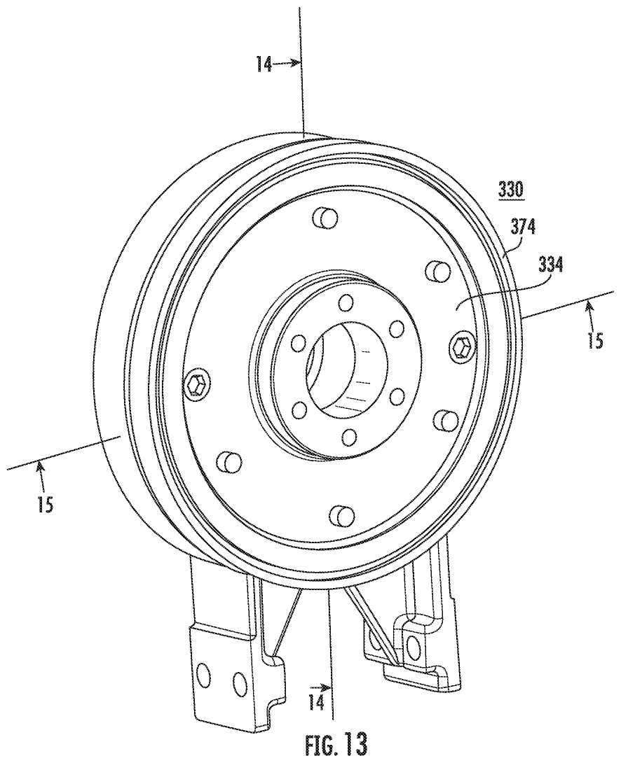

Turning now to FIGS. 11 and 12, a rotary damper generally designated 230 is illustrated. Rotary damper 230 is substantially identical to rotary damper 30 with alterations made to the shear structure carried within a damper material chamber 260. In this embodiment, the shear structures are raised, concentric walls 272 formed in surface 245 of body 236 and concentric walls 274 formed in surface 251 of top plate 234 and loosely interdigitated with walls 272. As walls 272 and 274 pass each other during relative rotation of top plate 234 and body 236, they shear the damper material carried within damper material chamber 260. It will be understood that while the present embodiment, rotary damper 230, is essentially similar to rotary damper 30 with different shear structures, these shear structures, concentric walls 272 and 274, can also replace the shear structure in rotary damper 130.

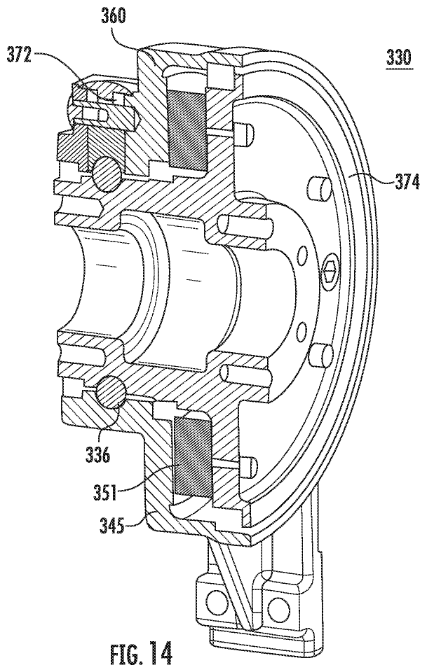

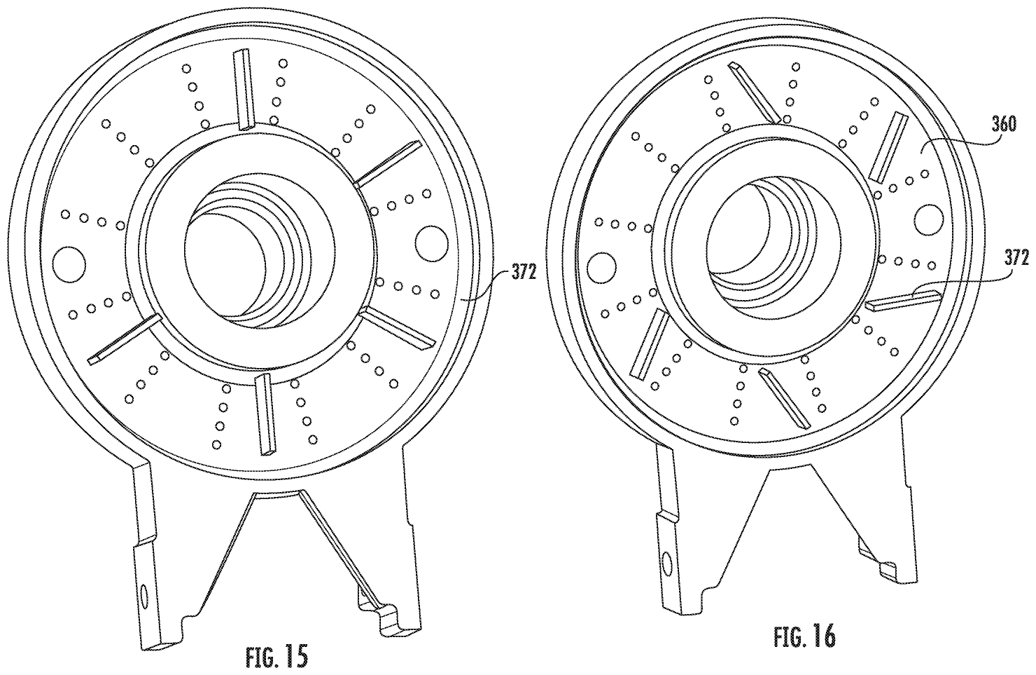

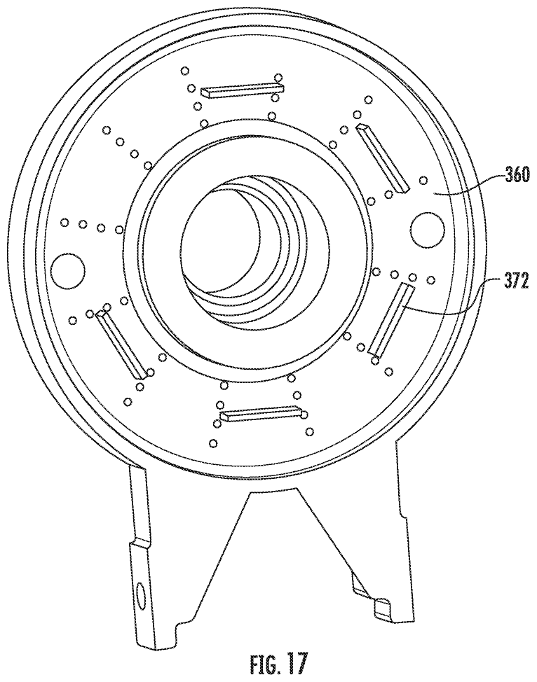

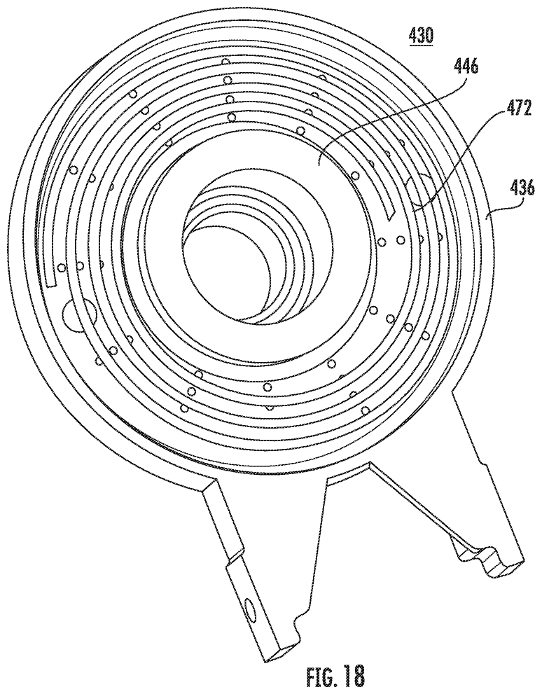

Referring to FIGS. 13 and 14, a rotary damper generally designated 330 is illustrated. Rotary damper 330 is substantially identical to rotary damper 30 with alteration made to the shear structure carried within damper material chamber 360. In this embodiment, the shear structures are selectively rotatable vanes 372 carried between surface 345 of body 336 and surface 351 of top plate 334. Vanes 372 are rotatably coupled to actuators 374 carried outside of material chamber 360, preferably carried on an outer surface of top plate 334. Actuators 374 can be small electric motors having shafts extending through top plate 334 and coupled to vanes 372. Vanes 372 are spaced around top plate 334 to provide a dispersed positioning of vanes within damper material chamber 360. Vanes 372 are movable between a full shear orientation and a minimal shear orientation, as illustrated in FIG. 14, with additional reference to FIG. 15, in the full shear orientation, vanes 372 extend radially outwardly to provide a large shearing surface within shear material cavity 360. FIG. 16 illustrates vanes 372 in a partial shear orientation midway between full shear orientation and minimal shear orientation. FIG. 17 illustrates vanes 372 in a minimal shear orientation to provide as small a shearing surface as possible. Actuators 374 can be used to position vanes 372 in substantially any orientation desired. It will be understood that while the present embodiment, rotary damper 330, is essentially similar to rotary damper 30 with different shear structures, these shear structures, vanes 372, can also replace the shear structure in rotary damper 130.

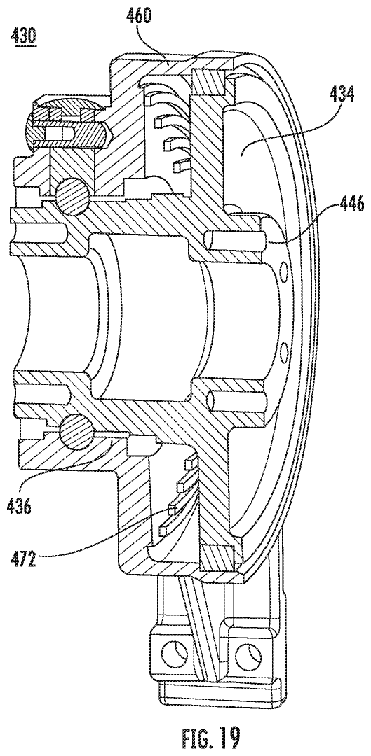

Referring now to FIGS. 18 and 19, a rotary damper generally designated 430 is illustrated. Rotary damper 430 is substantially identical to rotary damper 30 with alteration made to the shear structure carried within damper material chamber 460, replacing it with a damper structure. Instead of using damper material a coil spring 472 is carried within damper material chamber 460, encircling torque structure interface 446. Coil spring 472 stores energy as body 436 and top plate 434 rotate off an equilibrium point, and then provides torque to return to equilibrium. It will be understood that a damper material may be, or may not be used to fill damper material chamber 460. In either case, coil spring 472 alone or in combination with any damper material used are considered to come within the definition of a shear structure. It will be understood that while the present embodiment, rotary damper 430, is essentially similar to rotary damper 30 with different shear structures, these shear structures, coil spring 472 with or without damper material, can also replace the shear structure in rotary damper 130.

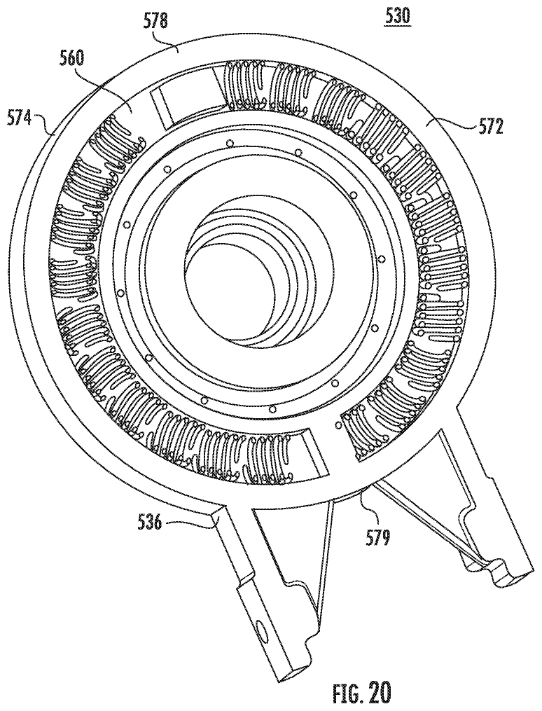

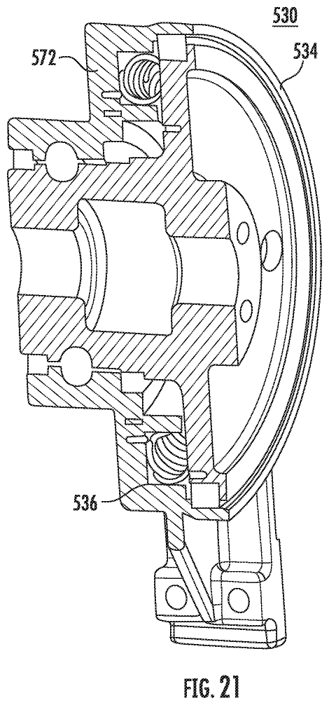

Turning now to FIGS. 20 and 21, a rotary damper generally designated 530 is illustrated. Rotary damper 530 is substantially identical to rotary damper 30 with alteration made to the shear structure carried within damper material chamber 560, replacing it with a different damper structure. Instead of using damper material, compression springs 572 and 574 are carried within damper material chamber 560, encircling torque structure interface 546. Compression springs 572 and 574 each extend in opposite directions around torque structure interface 546 from a starting point on opposite sides of a tab 578 carried by top plate 534 and extending into chamber 560. Compression springs 572 and 574 terminate at a stop member 579 extending into chamber 560 from body 536. Rotation of top plate 534 relative to body 536 in a clockwise direction causes tab 578 to travel within chamber 560 in the clockwise direction, compressing compression spring 572 against stop member 579. Rotation of top plate 534 relative to body 536 in a counter-clockwise direction causes tab 578 to travel within chamber 560 in the counter-clockwise direction, compressing compression spring 574 against stop member 579. Compression of either compression spring 572 or 574 stores energy as body 536 and top plate 534 rotate off an equilibrium point, and then provides torque to return to equilibrium. It will be understood that a damper material may be, or may not be used to fill damper material chamber 560. In either case, compression springs 572 and 574 alone or in combination with any damper material used are considered to come within the definition of a shear structure. It will be understood that while the present embodiment, rotary damper 530, is essentially similar to rotary damper 30 with different shear structures, these shear structures, compression springs 572 and 574 along with damper material that may or may not be included, can also replace the shear structure in rotary damper 130.

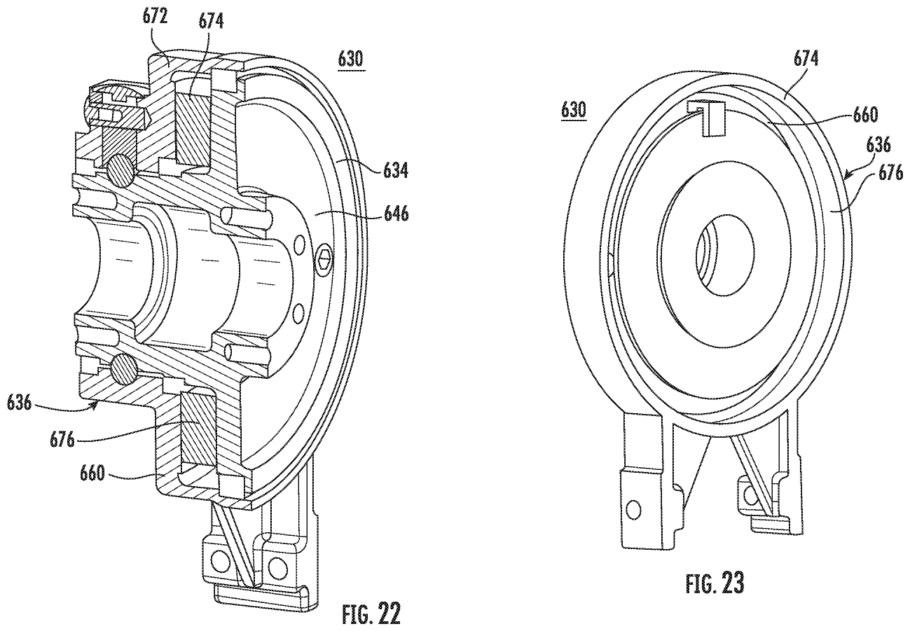

Turning now to FIGS. 22 and 23, a rotary damper generally designated 630 is illustrated. Rotary damper 630 is substantially identical to rotary damper 30 with alteration made to the shear structure carried within a damper material chamber 660, replacing it with a damper structure. Instead of using damper material, a disc brake 672 is carried within damper material chamber 660, encircling torque structure interface 646. Disc brake 672 includes a caliper 674 coupled to body 636 and carried within damping material chamber 660. Disc 676 extends radially inwardly from torque structure interface into damping material chamber 660 and is engaged in a conventional manner by caliper 674. Caliper 674 can be actuated hydraulically or electrically to either remove the braking force or add the braking force depending on the application of the system in which it is used. While a disc brake is shown, it will be understood that the disc brake can be mounted outside the damper material chamber or can be replaced with a drum brake. It will also be understood that while the present embodiment, rotary damper 630, is essentially similar to rotary damper 30 with different shear structures, these shear structures, disc brake 572, can also replace the shear structure in rotary damper 130.

Thus, a new and improved rotary damper is disclosed that provides a non-linear dampening response. The new and improved rotary damper in a preferred embodiment forms a cavity between relatively rotatable components. The cavity is filled with a dilatant damper material and shear elements (components of a shear structure or structures) are affixed to at least one of the relatively rotatable components so as to extend into the dilatant damper material and produce a damping action in response to relative rotation.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A rotary damper comprising:
a tubular body having interface elements attached thereto for fixedly mounting the body on a mounting structure;
a torque structure interface rotatably mounted within the tubular body so as to define a cavity, the cavity having opposed spaced apart surfaces, one of the spaced apart surfaces being a part of the tubular body and the other of the spaced apart surfaces being a part of the torque structure interface, and the torque structure interface being tubular shaped to receive a torque structure therethrough for mutual rotation of the torque structure interface and the torque structure; and
shear structures positioned in the cavity and providing damping on the torque structure interface relative to the tubular body during rotation of the torque structure interface relative to the tubular body.

2. The rotary damper as claimed in claim 1 wherein the torque structure interface is rotatably mounted within the body by bearings.

3. The rotary damper as claimed in claim 1 wherein the shear structures include dilatant damper material filling the cavity and pins extending into the dilatant damper material from one or both of the opposed spaced apart surfaces of the cavity.

4. The rotary damper as claimed in claim 3 wherein the shear structures include dilatant damper material filling the cavity and pins extending into the dilatant damper material from both of the opposed spaced apart surfaces of the cavity, a first half of the pins extending from one of the opposed spaced apart surfaces and a second half of the pins extending from the other of the opposed spaced apart surfaces, the first half of the pins and the second half of the pins being staggered for inter-passing during relative rotation of the torque structure interface and the body.

5. The rotary damper as claimed in claim 1 wherein the shear structures include dilatant damper material filling the cavity and first raised, concentric walls extending into the dilatant damper material from a first of the opposed spaced apart surfaces of the cavity and second raised, concentric walls extending into the dilatant damper material from a second of the opposed spaced apart surfaces of the cavity, the first raised, concentric walls and the second raised, concentric walls being loosely interdigitated to allow for relative rotation therebetween.

6. The rotary damper as claimed in claim 1 wherein the shear structures include dilatant damper material filling the cavity and a plurality of selectively rotatable vanes extending into the dilatant damper material from a first of the opposed spaced apart surfaces forming a part of the torque structure interface, and externally accessible actuators affixed to the selectively rotatable vanes for moving the selectively rotatable vanes between a full shear orientation and a minimal shear orientation.

7. The rotary damper as claimed in claim 6 wherein the externally accessible actuators are a plurality of electric motors, one each of the plurality of electric motors affixed to each selectively rotatable vane.

8. The rotary damper as claimed in claim 1 wherein the shear structures includes a coil spring wound around the torque structure interface and affixed so as to store energy as the body and torque structure interface rotate off an equilibrium point, and then provides torque to return the torque structure interface to equilibrium.

9. The rotary damper as claimed in claim 8 wherein the shear structures further include dilatant damper material filling the cavity.

10. The rotary damper as claimed in claim 1 wherein the shear structures include compression springs positioned in the cavity and extending in opposite directions around the torque structure interface from a first tab carried by the torque structure interface to a stop member extending into the chamber from the body.

11. The rotary damper as claimed in claim 10 wherein the shear structures further include dilatant damper material filling the cavity.

12. A rotary damper comprising:
a tubular body having interface elements attached thereto for fixedly mounting the body on a mounting structure;
a torque structure interface rotatably mounted within the body so as to define a cavity, the cavity having opposed spaced apart surfaces, one of the spaced apart surfaces being a part of the body and the other of the spaced apart surfaces being a part of the torque structure interface, and the torque structure interface being tubular shaped to receive a torque structure therethrough for mutual rotation of the torque structure interface and the torque structure;
shear structures positioned in the cavity and including dilatant damper material filling the cavity and shear elements extending into the dilatant damper material from one or both of the opposed spaced apart surfaces of the cavity, the shear elements in cooperation with the dilatant damper material providing damping on the torque structure interface relative to the tubular body during rotation of the torque structure interface relative to the tubular body.

13. The rotary damper as claimed in claim 12 wherein the shear elements include pins extending into the dilatant damper material from one or both of the opposed spaced apart surfaces of the cavity.

14. The rotary damper as claimed in claim 13 wherein the shear elements include pins extending into the dilatant damper material from both of the opposed spaced apart surfaces of the cavity, a first half of the pins extending from one of the opposed spaced apart surfaces and a second half of the pins extending from the other of the opposed spaced apart surfaces, the first half of the pins and the second half of the pins being staggered for inter-passing during relative rotation of the torque structure interface and the body.

15. The rotary damper as claimed in claim 12 wherein the shear elements include first raised, concentric walls extending into the dilatant damper material from a first of the opposed spaced apart surfaces of the cavity and second raised, concentric walls extending into the dilatant damper material from a second of the opposed spaced apart surfaces of the cavity, the first raised, concentric walls and the second raised, concentric walls being loosely interdigitated to allow for relative rotation therebetween.

16. The rotary damper as claimed in claim 12 wherein the shear elements include a plurality of selectively rotatable vanes extending into the dilatant damper material from a first of the opposed spaced apart surfaces forming a part of the torque structure interface, and externally accessible actuators affixed to the selectively rotatable vanes for moving the selectively rotatable vanes between a full shear orientation and a minimal shear orientation.

17. The rotary damper as claimed in claim 16 wherein the externally accessible actuators are a plurality of electric motors, one each of the plurality of electric motors affixed to each selectively rotatable vane.

18. A rotary damper incorporated into a solar tracking system, the solar tracking system including a plurality of linearly spaced apart posts with a longitudinal axis of rotation extending there between, a torque structure carrying solar panels rotatably mounted on the posts for limited rotation around the longitudinal axis, the rotary damper comprising:
a tubular body having interface elements attached thereto for fixedly mounting the body on one of the linearly spaced apart posts;
a torque structure interface rotatably mounted within the body so as to define a cavity, the cavity having opposed spaced apart surfaces, one of the spaced apart surfaces being a part of the body and the other of the spaced apart surfaces being a part of the torque structure interface, and the torque structure interface being tubular shaped to receive the torque structure therethrough for mutual rotation of the torque structure interface and the torque structure; and
shear structures positioned in the cavity and including dilatant damper material filling the cavity and shear elements extending into the dilatant damper material from one or both of the opposed spaced apart surfaces of the cavity, the shear elements in cooperation with the dilatant damper material providing damping on the torque structure interface relative to the tubular body during rotation of the torque structure interface relative to the tubular body.

19. The rotary damper as claimed in claim 18 wherein the shear elements include pins extending into the dilatant damper material from both of the opposed spaced apart surfaces of the cavity, a first half of the pins extending from one of the opposed spaced apart surfaces and a second half of the pins extending from the other of the opposed spaced apart surfaces, the first half of the pins and the second half of the pins being staggered for inter-passing during relative rotation of the torque structure interface and the body.

20. The rotary damper as claimed in claim 18 wherein the shear structures produce a damping torque of approximately zero NM (Newton-meters) at relative rotary speeds of 0.1 RPM between the tubular body and the torque structure interface and below and a dampening torque greater than 1000 NM at rotary speeds higher than 0.1 RPM.
